(19) United States
(12) Patent Application Publication
(10) Pub. No.: US 2026/0163855 A1
(43) Pub. Date: Jun. 11, 2026

(54) SYSTEM

(71) Applicant: SoftBank Group Corp., Tokyo (JP)

(72) Inventor: Misa INOME, Tokyo (JP)

(21) Appl. No.: 19/412,271

(22) Filed: Dec. 8, 2025

(30) Foreign Application Priority Data
Dec. 10, 2024 (JP) 2024-215836
Nov. 17, 2025 (JP) 2025-196572

(51) Int. Cl. H04L 51/212

(52) U.S. Cl. CPC H04L 51/212

(57) ABSTRACT

A system according to the present application includes: a reception unit configured to receive content information regarding a content used by a user in a predetermined messaging service; a determination unit configured to determine whether the user is allowed to use the content by inputting the content information, age information regarding the user, and an instruction statement instructing an output of whether the user is allowed to use the content, to a trained model that generates answers to input questions; and a decision unit configured to decide a manner of use of the content by the user based on determination result from the determination unit.

### CROSS-REFERENCE TO RELATED APPLICATION

The present application claims priority to and incorporates by reference the entire contents of Japanese Patent Application No. 2024-215836 filed in Japan on Dec. 10, 2024 and Japanese Patent Application No. 2025-196572 filed in Japan on Nov. 17, 2025, the entire contents of which are incorporated herein by reference.

### BACKGROUND OF THE INVENTION

### 1. Field of the Invention

The present invention relates to a system.

### 2. Description of the Related Art

Conventionally, technologies for providing various types of information to users via the Internet are known. As one example of such technologies, techniques for restricting viewing of contents according to a user's age are known (see Japanese Unexamined Patent Publication No. 2019-205026).

However, in the above conventional technology, it is not always possible to provide content in a messaging service in a manner corresponding to a user's age.

### SUMMARY OF THE INVENTION

A system according to the present application includes: a reception unit configured to receive content information regarding a content used by a user in a predetermined messaging service; a determination unit configured to determine whether the user is allowed to use the content by inputting the content information, age information regarding the user, and an instruction statement instructing an output of whether the user is allowed to use the content, to a trained model that generates answers to input questions; and a decision unit configured to decide a manner of use of the content by the user based on determination result from the determination unit.

### BRIEF DESCRIPTION OF THE DRAWINGS

FIG. 1 is a diagram illustrating an example of information processing according to an embodiment;

FIG. 2 is a diagram illustrating an example of a screen of a user terminal 100-1 according to the embodiment;

FIG. 3 is a diagram illustrating an example configuration of an information processing device 10 according to the embodiment;

FIG. 4 is a diagram illustrating an example of a user information database 31; and

FIG. 5 is a flowchart illustrating an example of an information processing procedure according to the embodiment.

### DETAILED DESCRIPTION OF THE PREFERRED EMBODIMENTS

Hereinafter, an embodiment (hereinafter referred to as “the embodiment”) for implementing a system according to the present application will be described in detail with reference to the drawings. Note that the system according to the present application is not limited by this embodiment. In the following embodiments, the same reference numerals are assigned to identical parts, and redundant descriptions are omitted. In the embodiments described below, “content” refers to a broad concept including messages sent and received by users in a messaging service, as well as advertisements, images, videos, audio, and service functions (such as payment functions and call functions) distributed on the service.

### 1. Embodiment

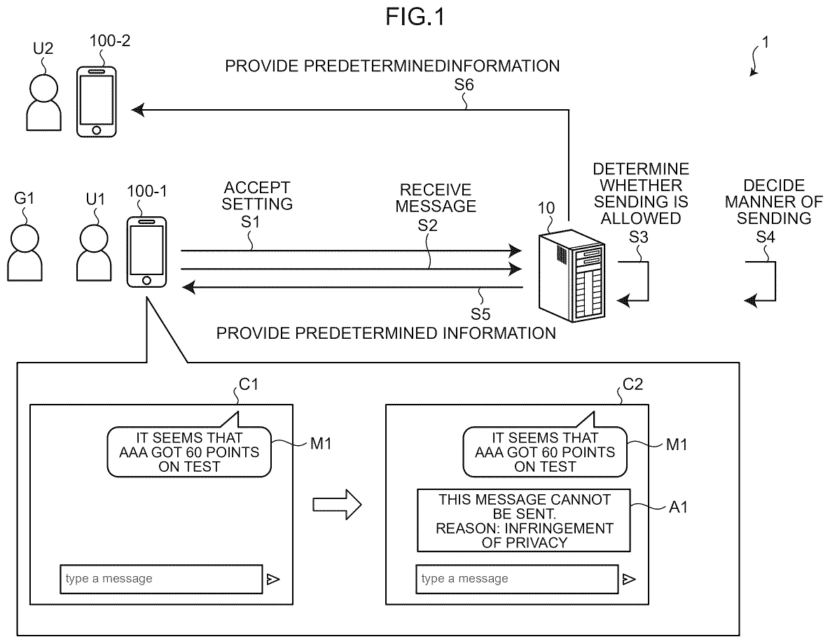

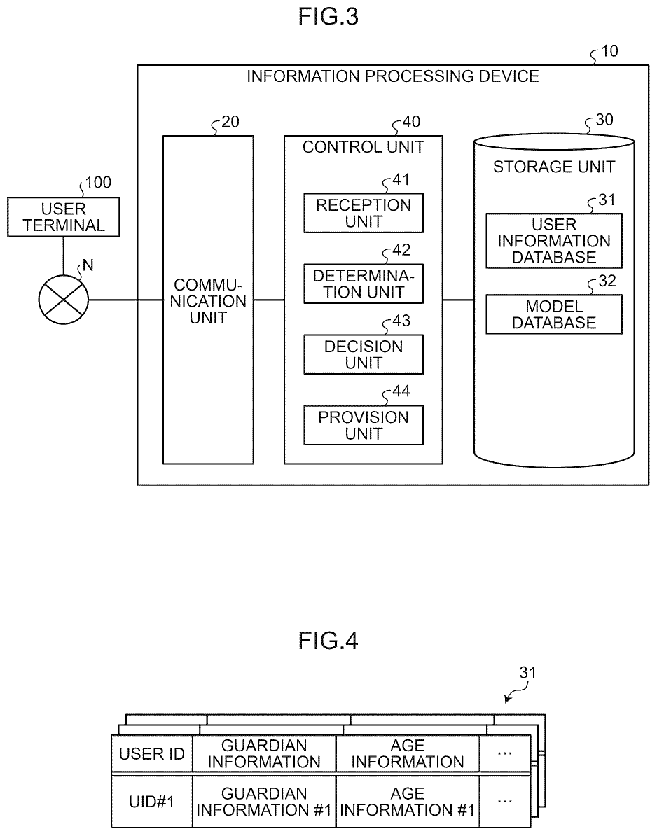

Information processing realized by a system of the present embodiment will be described with reference to FIG. 1. FIG. 1 is a diagram illustrating an example of information processing according to the embodiment. In FIG. 1, it is assumed that information processing according to the embodiment is realized by a system 1, which is an example of the system according to the present application. As shown in FIG. 1, the system 1 according to the embodiment includes an information processing device 10 and a user terminal 100. The information processing device 10 and the user terminal 100 are communicably connected to each other via a network N (see, for example, FIG. 3) by a wired or wireless manner. The network N is, for example, a WAN (Wide Area Network) such as the Internet. Note that the information processing system 1 shown in FIG. 1 may include the plurality of information processing devices 10 and the plurality of user terminals 100.

The information processing device 10 shown in FIG. 1 provides a messaging service 1 for exchanging messages between users and for exchanging messages between users and official accounts (for example, accounts managed by companies or stores), to users and administrators who manage official accounts. Specifically, the information processing device 10 provides messaging service #1 to users for exchanging messages with other users linked to the user (in other words, other users registered as friends by the user) and with official accounts linked to the user (in other words, official accounts registered as friends by the user).

The information processing device 10 may also function as a web server that provides a website related to the messaging service #1. In addition, the information processing device 10 may be a device that distributes information to be displayed in a messaging application related to the messaging service #1 installed on the user terminal 100. Furthermore, the information processing device 10 may be a server that distributes data of the messaging application itself.

The information processing device 10 may also function as a distribution device that distributes control information to the user terminal 100. Here, control information may be described in a script language such as JavaScript (registered trademark), a style sheet language such as CSS (Cascading Style Sheets), or a programming language such as Java (registered trademark), Kotlin, Swift, or Objective-C. Application itself distributed from the information processing device 10 may also be regarded as control information.

Hereinafter, an example of information processing performed by the information processing device 10 will be described with reference to FIG. 1. In the following description, it is assumed that a user terminal 100-1 is used by a user (user U1) identified by a user ID “UID #1”. In the following description, the user terminal 100-1 may be regarded as equivalent to the user U1. That is, in the following description, the user U1 may be read as the user terminal 100-1.

In the following description, it is assumed that a user terminal 100-2 is used by a user (user U2) identified by a user ID “UID #2”. In the following description, the user terminal 100-2 may be regarded as equivalent to the user U2. That is, in the following description, the user U2 may be read as the user terminal 100-2.

In the following description, it is assumed that the messaging application is pre-installed on the user terminals 100-1 and 100-2.

In the following description, it is assumed that the user U1, who is below a predetermined age (for example, 15 years old or younger), is protected by a guardian G1 (for example, the father, mother, grandfather, grandmother, sister, or brother of user U1).

First, the information processing device 10 receives filtering settings (hereinafter, “Filtering Setting #1”) related to filtering when the user U1 uses the messaging application, from the user terminal 100-1 (step S1). For example, the user terminal 100-1 launches the messaging application, displays an input screen for entering the Filtering Setting #1 for messages sent and received by the user U1 in the messaging application, and receives input of the Filtering Setting #1 from the guardian G1 on the input screen. Specifically, the user terminal 100-1 displays an input screen when authentication information (for example, a password) linked to the guardian G1 is entered, and receives input of the Filtering Setting #1 from the guardian G1 on the input screen.

Then, the information processing device 10 receives the Filtering Setting #1 from the user terminal 100-1 and manages the Filtering Setting #1 in its own storage unit in association with user U1.

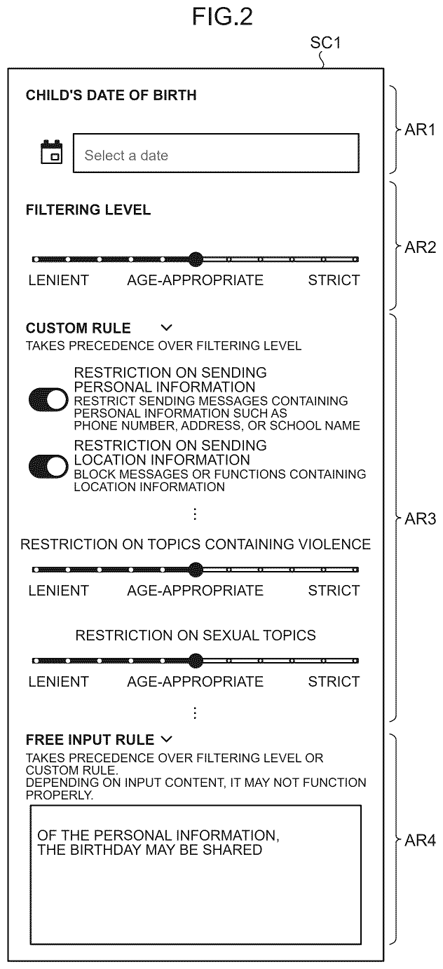

Here, the input screen displayed by the user terminal 100-1 will be described with reference to FIG. 2. FIG. 2 is a diagram illustrating an example of a screen of the user terminal 100-1 according to the embodiment.

As shown in FIG. 2, the user terminal 100-1 displays an input screen SC1 and receives input of the Filtering Setting #1. For example, the user terminal 100-1 displays the screen SC1 including an area AR1 for entering a date of birth (in other words, the age) of the user U1, an area AR2 for entering a filtering level according to an age of the user U1, an area AR3 for entering information regarding customization of filtering, and an area AR4 for the guardian G1 to enter arbitrary rules (text information).

Specifically, the user terminal 100-1 receives, in the area AR3, a specification of whether to allow the user U1 to send messages indicating personal information (for example, a phone number of the user U1, an address of the user U1, a school name attended by the user U1, etc.) or location information. In addition, the user terminal 100-1 receives, in the area AR3, a filtering level for messages on topics containing violent expressions or sexual topics.

The information processing device 10 may also display an input screen on a terminal device used by the guardian G1 and receive the Filtering Setting #1 from a terminal device used by the guardian G1 by having information entered.

Returning to FIG. 1, the description continues. Next, the information processing device 10 receives a message sent by the user U1 to user U2 using the messaging application (step S2). For example, the user U1 launches the messaging application installed on the user terminal 100-1, enters a message M1 “It seems that AAA got 60 points on the test” to be sent to the user U2 on a displayed screen C1, and the information processing device 10 receives the message M1 from the user terminal 100-1 in response to an operation of the user U1 to send the message M1.

Next, the information processing device 10 determines whether sending of the message M1 by the user U1 is allowed (step S3). For example, the information processing device 10 determines whether the sending of the message M1 by the user U1 is allowed by using message information regarding the message M1 (for example, text information indicating the message M1), the Filtering Setting #1, and a trained model #1 that generates answers to input questions. Specifically, the information processing device 10 determines whether sending of the message M1 by the user U1 is allowed by inputting message information regarding the message M1, the Filtering Setting #1, and an instruction statement instructing an output of whether sending of the message M1 by the user U1 is allowed based on the Filtering Setting #1, to model #1.

More specifically, the information processing device 10 outputs whether sending of the message M1 by the user U1 is allowed based on the Filtering Setting #1, and further, in the case where the sending of the message M1 by the user U1 is not allowed, inputs to the model #1 an instruction statement instructing an output of the reason for being not allowed, together with message information regarding the message M1 and the Filtering Setting #1. Thus, the information processing device 10 determines whether the sending of the message M1 by the user U1 is allowed, and, if the sending is not allowed, determines the reason for being not allowed.

The model #1 is a model trained to output an answer sentence corresponding to an input question sentence, and is a language model that performs natural language processing, such as GPT (Generative Pre-trained Transformer) or Transformer. The model #1 is located within the information processing device 10 and is independently created by an operator managing the information processing device 10. It is desirable that input information, such as personal information, is kept confidential by training so that the input information is not used as new answers.

Next, the information processing device 10 decides a manner of sending the message M1 (step S4). For example, if it is determined that sending of the message M1 by the user U1 is allowed, the information processing device 10 decides to send the message M1 to a recipient user without blocking the sending of the message M1. If it is determined that sending of the message M1 by the user U1 is not allowed, the information processing device 10 decides to block the sending of the message M1 and provide the reason for being not allowed.

Here, in the example of FIG. 1, it is assumed that sending of the message M1 by the user U1 is determined to be not allowed. In such a case, the information processing device 10 blocks sending of the message M1 and provides predetermined information to the user terminal 100-1 (step S5). For example, the information processing device 10 displays an alert A1 on a screen C2 indicating that the sending of the message M1 has been blocked and the reason for being not allowed (for example, “Reason: Privacy violation”).

Next, the information processing device 10 provides predetermined information to the user terminal 100-2 (step S6). For example, the information processing device 10 provides an alert indicating that sending of the message M1 by the user U1 has been blocked and the reason for being not allowed.

The information processing device 10 may also provide an alert indicating that sending of the message M1 has been blocked and the reason for being not allowed to a terminal device used by the guardian G1. If the guardian G1 performs an operation to allow sending of the message M1, the information processing device 10 may release the block on the message M1 and send the message M1 to the user terminal 100-2. The information processing device 10 may also receive information regarding update of the Filtering Setting #1 from a terminal device used by the guardian G1.

The information processing device 10 may also determine whether reception of a message sent to the user U1 by another user using the messaging application (in other words, a message received by the user U1) is allowed. For example, the information processing device 10 receives a message M2 sent by the user U2 to the user U1 using the messaging application, from the user terminal 100-2.

Next, the information processing device 10 determines whether reception of the message M2 by the user U1 is allowed by using message information regarding the message M2 (for example, text information indicating the message M2), the Filtering Setting #1, and the model #1. For example, the information processing device 10 outputs whether reception of the message M2 by the user U1 is allowed based on the Filtering Setting #1, and further, in a case where reception of the message M2 by the user U1 is not allowed, inputs to the model #1 an instruction statement instructing an output of the reason for being not allowed, together with message information regarding the message M2 and the Filtering Setting #1. Thus, the information processing device 10 determines whether reception of the message M2 by the user U1 is allowed, and, if reception is not allowed, determines reason for being not allowed.

Next, if it is determined that reception of the message M2 by the user U1 is allowed, the information processing device 10 decides not to block the message M2 and sends the message M2 to the user U1, and sends the message M2 to the user terminal 100-1.

If it is determined that reception of the message M2 by the user U1 is not allowed, the information processing device 10 decides to block sending of the message M2 and provide the reason for being not allowed. The information processing device 10 blocks the message M2 sent by the user U2, displays an alert on the user terminal 100-1 indicating that the message M2 has been blocked and the reason for being not allowed, and provides information indicating that the message M2 has been blocked and the reason why the reception of the message M2 by the user U1 is not allowed to the user terminal 100-2.

In recent years, messaging services have become widespread, and, for example, children such as elementary and junior high school students may use them. However, in messaging services, there is a possibility of exchanging messages with inappropriate persons for children or exchanging messages with inappropriate content for children. On the other hand, children may use messaging services to consult about school events and the like. That is, conventional messaging services may be inappropriate for children, but are necessary for children's lives, so designs that allow children to use them safely have been required.

Therefore, the information processing device 10 according to the embodiment decides the manner of sending and receiving messages using filtering settings corresponding to the user's age and a model (for example, generative AI). For example, conventionally, filtering has been performed mainly based on prohibited words, but the information processing device 10 according to the embodiment can determine, using generative AI, whether a message is inappropriate for children based on a context of the message. For example, even a message such as “It seems that AAA got 60 points on the test,” which apparently does not contain prohibited words, may be determined to be an inappropriate message that infringes privacy, and sending and receiving of such a message may be determined to be not allowed.

A model used in determination unit 42 receives, as an input, message information in messaging service, user's age information, filtering setting information by a guardian, and the like. The model is trained to contextually analyze these pieces of information and infer whether the input message is inappropriate for a user.

An input to a model is configured together with an instruction statement such as “Judge whether a message can be sent or not based on the message content and user attributes.” The model interprets this input, including the instruction statement, as natural language, generates and outputs a response sentence indicating whether the message can be sent. The response sentence includes determination results such as “allowed,” “not allowed,” or “guardian confirmation required.”

In addition to the determination result, the model can generate a natural language sentence indicating the reason for the determination. This reason sentence includes explanations such as “Sending not allowed because personal information is included” or “Advertisement viewing restricted due to age setting,” and is presented to the user terminal 100 or a terminal device used by a guardian.

The determination unit 42 notifies a decision unit 43 whether to allow or block message sending based on the determination result output from a model. Thus, by utilizing semantic understanding by the model, message sending and receiving control corresponding to a user's age and filtering settings can be realized with high accuracy.

Furthermore, the information processing device 10 according to the embodiment can determine whether to allow message sending and receiving by continuously training a model used for determination, thereby responding to newly emerging slang and the like.

From the above, the information processing device 10 according to the embodiment can provide content in a messaging service in a manner corresponding to a user's age.

Furthermore, the information processing device 10 according to the embodiment can relax usage restrictions of the messaging service by filtering as a user (child) grows older, and when the user becomes an adult (for example, 18 years or older), can provide functions equivalent to those used by adults, thereby preventing users from leaving the messaging service.

According to the above configuration, the information processing device 10 analyzes a context (for example, meaning or intent) contained in content such as messages based on contextual understanding using a model, for example, a generative AI model. The information processing device 10 can determine inappropriateness of content such as messages with high accuracy.

As a result, the information processing device 10 can reduce erroneous determinations of inappropriateness of content such as messages compared to conventional keyword matching methods, and can realize optimal control considering age information and settings by a guardian. Furthermore, since a generative AI model makes determinations in real time in cooperation with a communication control system, the information processing device 10 can immediately determine whether to allow message sending or advertisement distribution, thereby suppressing communication delays. In addition, by generating and providing the reason for the determination in natural language, users and guardians can easily understand the basis for the result. Therefore, the information processing device 10 can enhance transparency of filtering processing and reliability of the entire system.

Accordingly, the information processing device 10 according to the present embodiment can simultaneously realize high accuracy, immediacy, and reliability in content provision, and provide a safe and highly reliable messaging service corresponding to user's age and situation.

### 2. Other Processing Examples

The above-described processing is merely an example, and the information processing device 10 may perform various processing using various types of information. Examples are listed below.

### 2-1. Regarding Filtering Settings

In the example of FIG. 1, the information processing device 10 may determine whether sending of the message M1 by the user U1 is allowed using the Filtering Setting #1 in any manner. For example, the information processing device 10 may prioritize information regarding customization of filtering entered in the area AR3 or rules arbitrarily entered in the area AR4 over a filtering level entered in the area AR2, and determine whether sending of the message M1 is allowed.

For example, even if a filtering level entered in the area AR2 determines that sending a message containing personal information is allowed, if sending such a message is not permitted in the area AR3, the information processing device 10 determines that sending a message containing personal information is not allowed. Conversely, even if a filtering level entered in the area AR2 determines that sending a message containing personal information is not allowed, if only a date of birth is set to be shareable in the area AR4, the information processing device 10 determines that sending a message containing only the date of birth as personal information is allowed.

The information processing device 10 may use information (text information) arbitrarily entered in the area AR4 as an instruction statement to be input to the model #1.

2-2. Regarding Restrictions on Content Other than Messages

In the example of FIG. 1, the information processing device 10 may decide a manner of providing various types of content available in the messaging service to a user. For example, the information processing device 10 receives information regarding an advertisement 1 (for example, an advertisement distributed from an official account, etc.) distributed to the user U1 in the messaging service from a server device distributing the advertisement #1. The information processing device 10 determines whether to provide the advertisement #1 to the user U1 by inputting information regarding the advertisement #1, the Filtering Setting #1, and an instruction statement instructing an output of whether to provide the advertisement #1 to the user U1 based on the Filtering Setting #1, to the model #1. If it is determined that provision of the advertisement #1 is allowed, the information processing device 10 decides to provide the advertisement #1 to the user U1, and if it is determined that provision of the advertisement #1 is not allowed, the information processing device 10 decides to block the advertisement #1.

The information processing device 10 also receives information regarding an image #1 (for example, moving images or still images) distributed to the user U1 in the messaging service from a server device distributing the image #1 or a terminal device used by a distributor of the image #1. The information processing device 10 determines whether to provide the image #1 to the user U1 by inputting information regarding the image #1, the Filtering Setting #1, and an instruction statement instructing an output of whether to provide the image #1 to the user U1 based on the Filtering Setting #1, to the model #1. If it is determined that provision of the image #1 is allowed, the information processing device 10 decides to provide the image #1 to the user U1, and if it is determined that the provision of the image #1 is not allowed, the information processing device 10 decides to block the image #1.

The information processing device 10 may also decide a manner of providing predetermined functions in the messaging service based on the Filtering Setting #1. For example, if an age of the user U1 is below a predetermined threshold (for example, 12 years old or younger), the information processing device 10 may decide not to provide payment functions, billing functions for specific content, or call functions (for example, open chat) in the messaging service to the user U1.

### 2-3. Regarding Messaging Service

In the example of FIG. 1, the messaging service #1 may be the same service as that provided to users of a predetermined age or older (i.e., adults). For example, the messaging service #1 may provide content to users below a predetermined age based on the manner determined by the above-described information processing, and provide content to users of a predetermined age or older without using the above-described information processing.

The messaging service #1 may also be a service different from that provided to users of a predetermined age or older. For example, the information processing device 10 may provide the messaging service #1 to users below a predetermined age, and provide messaging service #2, in which content is provided without using the above-described information processing, to users of a predetermined age or older.

### 2-4. Regarding Filtering Settings

Filtering settings are not limited to those shown in FIG. 2, and any settings may be possible. For example, the information processing device 10 may receive filtering settings such as restrictions on sending and receiving URLs (Uniform Resource Locator), restrictions on sending and receiving media files, prohibition of nighttime use of the messaging service #1, prohibition of messaging with users other than specified users (for example, friends), prohibition of sending and receiving slang, and may determine whether a user is allowed to use a content based on such filtering settings.

### 3. Configuration of Information Processing Device

Next, a configuration of the information processing device 10 will be described with reference to FIG. 3. FIG. 3 is a diagram illustrating an example configuration of the information processing device 10 according to the embodiment. As shown in FIG. 3, the information processing device 10 includes a communication unit 20, a storage unit 30, and a control unit 40.

### Regarding Communication Unit 20

The communication unit 20 is implemented, for example, by a NIC (Network Interface Card). The communication unit 20 is connected to the network N by wired or wireless manner and transmits and receives information with the user terminal 100 and the like.

### Regarding Storage Unit 30

The storage unit 30 is implemented, for example, by a semiconductor memory device such as a RAM (Random Access Memory) or a flash memory, or by a storage device such as a hard disk or optical disk. As shown in FIG. 3, the storage unit 30 includes a user information database 31 and a model database 32.

### Regarding User Information Database 31

The user information database 31 stores various types of information regarding users. Here, an example of information stored in the user information database 31 will be described with reference to FIG. 4. FIG. 4 is a diagram illustrating an example of the user information database 31. In the example of FIG. 4, the user information database 31 includes items such as “user ID,” “guardian information,” and “age information.”

A “User ID” indicates identification information for identifying a user. “Guardian information” indicates information regarding a user's guardian, and stores, for example, identification information for identifying a guardian and authentication information linked to the guardian. “Age information” indicates information regarding a user's age (for example, filtering settings in the example of FIG. 1), and stores, for example, a user's age, a filtering level set according to the age, information regarding customization of filtering, and rules arbitrarily set (entered) by a guardian.

That is, FIG. 4 shows an example in which information regarding a guardian of a user identified by a user ID “UID #1” is “Guardian Information #1,” and information regarding an age of the user is “Age Information #1.”

### Regarding Model Database 32

The model database 32 stores models trained to output answers to input questions.

### Regarding Control Unit 40

The control unit 40 is a controller, and is implemented, for example, by a CPU (Central Processing Unit) or MPU (Micro Processing Unit) executing various programs stored in an internal storage device of the information processing device 10 using RAM as a work area. The control unit 40 may also be implemented by an integrated circuit such as an ASIC (Application Specific Integrated Circuit) or FPGA (Field Programmable Gate Array). As shown in FIG. 3, the control unit 40 includes a reception unit 41, a determination unit 42, the decision unit 43, and a provision unit 44, and realizes or executes functions and operations of information processing described below.

### Regarding Reception Unit 41

The reception unit 41 receives content information regarding content used by a user in a predetermined messaging service. For example, in the example of FIG. 1, the reception unit 41 receives information regarding the advertisement #1 distributed to the user U1 in the messaging service. The reception unit 41 also receives information regarding the image #1 distributed to the user U1 in the messaging service.

The reception unit 41 may also receive message information regarding messages sent by a user. For example, in the example of FIG. 1, the reception unit 41 receives a message sent by the user U1 to the user U2 using the messaging application from the user terminal 100-1.

The reception unit 41 may also receive message information regarding messages received by a user. For example, in the example of FIG. 1, the reception unit 41 receives the message M2 sent by the user U2 to the user U1 using the messaging application from the user terminal 100-2.

### Regarding Determination Unit 42

The determination unit 42 determines whether a user is allowed to use a content by inputting content information, age information regarding the user, and an instruction statement instructing an output of whether the user is allowed to use the content, to a trained model that generates answers to input questions. For example, in the example of FIG. 1, the determination unit 42 refers to the storage unit 30 (for example, the user information database 31 or the model database 32), and determines whether the user U1 is allowed to use the content by inputting content information regarding the content, the Filtering Setting #1, and an instruction statement instructing an output of whether the user U1 is allowed to use the content based on the Filtering Setting #1, to the model #1.

The determination unit 42 may also determine whether a user is allowed to send a message by inputting message information, age information, and an instruction statement instructing an output of whether a user is allowed to send a message, to a model. For example, in the example of FIG. 1, the determination unit 42 determines whether the user U1 is allowed to send the message M1 by inputting message information regarding the message M1, the Filtering Setting Status: final #1, and an instruction statement instructing an output of whether the user U1 is allowed to send the message M1 based on the Filtering Setting #1, to the model #1. The determination unit 42 may also determine the reason why a user is not allowed to send a message by inputting to a model an instruction statement instructing an output of the reason for being not allowed when the user is not allowed to send a message. For example, in the example of FIG. 1, the determination unit 42 determines whether the user U1 is allowed to send the message M1 by outputting the result based on the Filtering Setting #1, and further, in the case where the user U1 is not allowed to send the message M1, inputs to the model #1 an instruction statement instructing an output of the reason for being not allowed, together with message information regarding the message M1 and the Filtering Setting #1, thereby determining whether the user U1 is allowed to send the message M1 and, if sending is not allowed, determining the reason for being not allowed.

The determination unit 42 may also determine whether a user is allowed to receive a message by inputting message information, age information, and an instruction statement instructing an output of whether the user is allowed to receive a message, to a model. For example, in the example of FIG. 1, the determination unit 42 determines whether the user U1 is allowed to receive the message M2 by inputting message information regarding the message M2, the Filtering Setting #1, and an instruction statement instructing an output of whether the user U1 is allowed to receive the message M2 based on the Filtering Setting #1, to the model #1.

The determination unit 42 may also determine the reason why a user is not allowed to receive a message by inputting to a model an instruction statement instructing an output of the reason for being not allowed when the user is not allowed to receive a message. For example, in the example of FIG. 1, the determination unit 42 determines whether the user U1 is allowed to receive the message M2 by outputting the result based on the Filtering Setting #1, and further, in a case where the user U1 is not allowed to receive the message M2, inputs to the model #1 an instruction statement instructing an output of the reason for being not allowed, together with message information regarding the message M2 and the Filtering Setting #1, thereby determining whether the user U1 is allowed to receive the message M2 and, if reception is not allowed, determining the reason for being not allowed.

The determination unit 42 may also determine whether a user is allowed to use content by inputting content information, age information, rules specified by a user's guardian, and an instruction statement instructing an output of whether the user is allowed to use a content according to the rules, to a model. For example, in the example of FIG. 1, the determination unit 42 determines whether the user U1 is allowed to use a content by inputting content information regarding the content, the Filtering Setting #1 set by the guardian G1 of the user U1, and an instruction statement instructing an output of whether the user U1 is allowed to use the content based on the Filtering Setting #1, to the model #1.

### Regarding Decision Unit 43

The decision unit 43 decides a manner of use of content by a user based on a determination result from the determination unit 42. For example, in the example of FIG. 1, the decision unit 43 decides a manner of use of content based on the determination result regarding whether the user U1 is allowed to use the content.

The decision unit 43 may also decide a manner of sending a message based on a determination result from the determination unit 42. For example, in the example of FIG. 1, the decision unit 43 decides a manner of sending the message M1 based on a determination result regarding whether the user U1 is allowed to send the message M1.

The decision unit 43 may also decide to block sending of a message when the determination unit 42 determines that a user is not allowed to send the message. For example, in the example of FIG. 1, if it is determined that the user U1 is allowed to send the message M1, the decision unit 43 decides not to block sending and to send the message M1 to a recipient user. If it is determined that the user U1 is not allowed to send the message M1, the decision unit 43 decides to block sending of the message M1.

The decision unit 43 may also decide to block sending of a message and provide information indicating the reason for being not allowed to a user when it is determined that the user is not allowed to send the message. For example, in the example of FIG. 1, if it is determined that the user U1 is not allowed to send the message M1, the decision unit 43 decides to block the sending of the message M1 and provide the reason for being not allowed.

The decision unit 43 may also decide a manner of receiving a message based on determination result from the determination unit 42. For example, in the example of FIG. 1, the decision unit 43 decides a manner of receiving the message M2 based on determination result regarding whether the user U1 is allowed to receive the message M2.

The decision unit 43 may also decide to block reception of a message when the determination unit 42 determines that a user is not allowed to receive the message. For example, in the example of FIG. 1, if it is determined that the user U1 is allowed to receive the message M2, the decision unit 43 decides not to block the message M2 and to send the message M2 to the user U1. If it is determined that the user U1 is not allowed to receive the message M2, the decision unit 43 decides to block sending of the message M2.

The decision unit 43 may also decide to block reception of a message and provide information indicating the reason for being not allowed to a user when it is determined that the user is not allowed to receive the message. For example, in the example of FIG. 1, if it is determined that the user U1 is not allowed to receive the message M2, the decision unit 43 decides to block sending of the message M2 and provide the reason for being not allowed.

### Regarding Provision Unit 44

The provision unit 44 provides information indicating that a message has been blocked to a message sender when the determination unit 42 determines that a user is not allowed to receive the message. For example, in the example of FIG. 1, if it is determined that the user U1 is not allowed to receive the message M2, the provision unit 44 provides information indicating that the message M2 has been blocked and the reason why the user U1 is not allowed to receive the message M2 to the user terminal 100-2.

### 4. Information Processing Flow

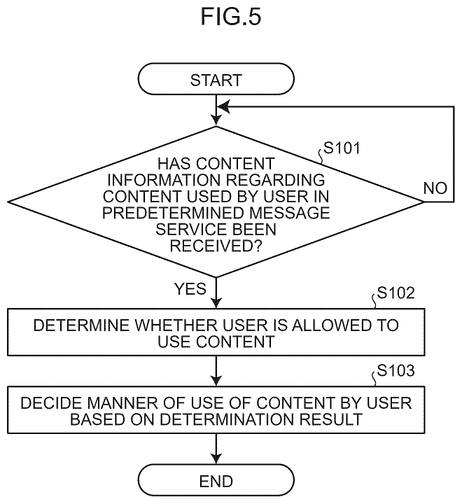

A procedure of information processing by the information processing device 10 according to the embodiment will be described with reference to FIG. 5. FIG. 5 is a flowchart illustrating an example of an information processing procedure according to the embodiment.

First, the information processing device 10 determines whether content information regarding content used by a user in a predetermined messaging service has been received (step S101). If content information has not been received (step S101; No), the information processing device 10 waits until content information is received.

On the other hand, if content information has been received (step S101; Yes), the information processing device 10 determines whether a user is allowed to use a content by inputting content information, age information regarding the user, and an instruction statement instructing an output of whether the user is allowed to use the content, to a trained model that generates answers to input questions (step S102). Next, the information processing device 10 decides a manner of use of a content by a user based on the determination result (step S103), and ends the processing.

### 5. Modified Examples

The above-described embodiment is merely examples, and various changes and applications are possible.

### 5-1. Regarding Processing Modes

Of the processes described in the above embodiment, all or part of the processes described as being performed automatically may be performed manually, and conversely, all or a part of the processes described as being performed manually may be performed automatically by known methods. In addition, unless otherwise specified, the processing procedures, specific names, and information including various data and parameters shown in the above text and drawings may be changed arbitrarily. For example, the various types of information shown in each figure are not limited to the illustrated information.

The components of each device shown in the drawings are functional concepts and do not necessarily have to be physically configured as illustrated. That is, the specific forms of distribution and integration of each device are not limited to those shown in the drawings, and all or part of them may be functionally or physically distributed or integrated in any unit according to various loads or usage conditions.

The above-described embodiments may be appropriately combined as long as processing contents do not conflict.

### 6. Others

Although several embodiments of the present application have been described in detail with reference to the drawings, these are examples, and the present invention can be implemented in other forms with various modifications and improvements based on the knowledge of those skilled in the art, including the modes described in the disclosure section of the invention.

In addition, the information processing device 10 described above may flexibly change its configuration, for example, by calling external platforms via API (Application Programming Interface) or network computing, depending on the function.

The “unit” described in the claims may be read as “means” or “circuit.” For example, the reception unit may be read as reception means or reception circuit.

What is claimed is:

1. A system comprising:
a reception unit configured to receive content information regarding a content used by a user in a predetermined messaging service;
a determination unit configured to determine whether the user is allowed to use the content by inputting the content information, age information regarding the user, and an instruction statement instructing an output of whether the user is allowed to use the content, to a trained model that generates answers to input questions; and
a decision unit configured to decide a manner of use of the content by the user based on determination result from the determination unit.

2. The system according to claim 1, wherein
the reception unit is configured to receive message information regarding messages sent by the user;
the determination unit is configured to determine whether the user is allowed to send the message by inputting the message information, the age information, and an instruction statement instructing an output of whether the user is allowed to send the message, to the model; and
the decision unit is configured to decide a manner of sending the message based on determination result from the determination unit.

3. The system according to claim 2, wherein
the decision unit is configured to decide to block sending of the message when the determination unit determines that the user is not allowed to send the message.

4. The system according to claim 2, wherein
the determination unit is configured to further determine a reason why the user is not allowed to send the message by inputting to the model an instruction statement instructing an output of a reason for being not allowed when the user is not allowed to send the message, and
the decision unit is configured to decide to block sending of the message and provide information indicating the reason for being not allowed to the user when it is determined that the user is not allowed to send the message.

5. The system according to claim 1, wherein
the reception unit is configured to receive message information regarding messages received by the user,
the determination unit is configured to determine whether the user is allowed to receive the message by inputting the message information, the age information, and an instruction statement instructing an output of whether the user is allowed to receive the message, to the model, and
the decision unit is configured to decide a manner of receiving the message based on determination result from the determination unit.

6. The system according to claim 5, wherein
the decision unit is configured to decide to block reception of the message when the determination unit determines that the user is not allowed to receive the message.

7. The system according to claim 5, wherein
the determination unit is configured to further determine a reason why the user is not allowed to receive the message by inputting to the model an instruction statement instructing an output of a reason for being not allowed when the user is not allowed to receive the message, and
the decision unit is configured to decide to block reception of the message and provide information indicating a reason for being not allowed to the user when it is determined that the user is not allowed to receive the message.

8. The system according to claim 5, further comprising:
a provision unit configured to provide information indicating that the message has been blocked to a message sender when the determination unit determines that the user is not allowed to receive the message.

9. The system according to claim 1, wherein
the determination unit is configured to determine whether the user is allowed to use the content by inputting the content information, the age information, rules specified by a user's guardian, and an instruction statement instructing an output of whether the user is allowed to use the content according to the rules, to the model.
